(19) United States
(12) Patent Application Publication
(10) Pub. No.: US 2018/0096358 A1
(43) Pub. Date: Apr. 5, 2018

(54) Methods and Systems for Managing User Experience Design

(71) Applicant: Wipro Limited, Bangalore (IN)

(72) Inventor: Anindita SUNDARAM, Bloomington, MN (US)

(73) Assignee: Wipro Limited

(21) Appl. No.: 15/282,060

(22) Filed: Sep. 30, 2016

(51) Int. Cl. G06Q 30/00; G06F 17/27

(52) U.S. Cl. CPC G06Q 30/016; G06F 17/274

(57) ABSTRACT

This disclosure relates to a method of managing user experience design. The method comprises receiving at least one business requirement, wherein the at least one business requirement comprises a plurality of elements; determining parts of speech associated with the at least one business requirement based on rules of grammar; determining dependencies between the parts of speech associated with the at least one business requirement; formatting the plurality of elements based on at least one of the dependencies, frequency of access, criticality of each of the plurality of elements or type of the end user, wherein the frequency of access and the criticality of each of the plurality of elements and the type of the end user is based on the at least one business requirement; and presenting the plurality of elements based on the formatting.

### TECHNICAL FIELD

The present invention relates to user experience design, in particular, to methods and systems for managing user experience design.

### BACKGROUND

Enterprises strive to cater to vast and varying audience through various means. For example, through promotions, discounts, cash-backs, gifts, etc. The ultimate objective is to attract and sustain maximum customers. However, differentiating factor between a successful and a failed product/service remains the ‘user experience’ that a product/service offers to end users. The user experience may vary according to types of users, types of activities performed by users using the product/service, frequency of such activities, and criticality of such activities.

Moreover, to ensure a world-class experience to the end users, the product/service needs to ensure “just-in-time” presentation of information, and access to related tasks. This is a problem statement for a product experience designer who is bounded to define designs based on conventional and time consuming methods.

Further, depending on volume of data being presented, design process may require unpredictable time. Lack of a measure in the design process may result in prolonged designing timelines. Thereby, the user experience designing process is often viewed as a subjective process that may take erratic amount of time and human effort, without promising a suitable output.

Nevertheless, quality of the user experience design, presently, does not aid traceability. It is further challenging to quantify ‘why design decisions were made’ or ‘why time and effort needs to be invested in a particular user group as compared with another’. This sometimes results in projects not engaging in the user experience design, at all, or investing far too much in it with inflated expectations.

Undeniably, delay in designing affects overall timeline of a product development lifecycle. As a consequence, overall schedule of a project may be affected if volume of data is too large to handle for humans, and if quality of the product (i.e., application or software) so produced is not deemed to be of the highest standard.

### SUMMARY

In one embodiment, a method of managing user experience design, the method comprising: receiving, by an element structuring device, at least one business requirement, wherein the at least one business requirement comprises a plurality of elements; determining, by the element structuring device, parts of speech associated with the at least one business requirement based on rules of grammar; determining, by the element structuring device, dependencies between the parts of speech associated with the at least one business requirement; formatting, by the element structuring device, the plurality of elements based on at least one of the dependencies, frequency of access, criticality of each of the plurality of elements or user type wherein the frequency of access, the criticality of each of the plurality of elements and the user type is based on the at least one business requirement; and presenting, by the element structuring device, the plurality of elements based on the formatting.

In another embodiment, a system for managing user experience design, the system comprising: at least one processor; a computer readable medium storing instructions that, when executed by the at least one processor, causes the processor to perform operations, the operations comprising: receiving at least one business requirement, wherein the at least one business requirement comprises a plurality of elements; determining parts of speech associated with the at least one business requirement based on rules of grammar; determining dependencies between the parts of speech associated with the at least one business requirement; formatting the plurality of elements based on at least one of the dependencies, frequency of access, criticality of each of the plurality of elements or user type, wherein the frequency of access, the criticality of each of the plurality of the elements and the user type is based on the at least one business requirement; and presenting the plurality of elements based on the formatting.

In yet another embodiment, a non-transitory computer-readable storage medium for managing user experience design comprising instructions, which when executed by a computing device, causes the computing device to: receive at least one business requirement, wherein the at least one business requirement comprises a plurality of elements; determine parts of speech associated with the at least one business requirement based on rules of grammar; determine dependencies between the parts of speech associated with the at least one business requirement; formatting the plurality of elements based on at least one of the dependencies, frequency of access, criticality of each of the plurality of elements or user type, wherein the frequency of access, the criticality of each of the plurality of elements and the user type is based on the at least one business requirement; and presenting the plurality of elements based on the formatting.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a diagram of an exemplary communication environment in which various embodiments may function.

FIG. 2 is a block diagram of an Element Structuring Device for structuring data into useful information, in accordance with an embodiment.

FIG. 3 is a block diagram of a processing module as part of the Element Structuring Device, in accordance with an embodiment.

FIG. 4 is a data table representing structured information utilized by the Element Structuring Device, in accordance with an embodiment.

FIG. 5 illustrates a flow chart of a method of managing user experience design, in accordance with an embodiment.

FIGS. 6A and 6B illustrate a flow chart of a method of structuring data related to user experience design based on rules of grammar, in accordance with an embodiment.

FIG. 7 illustrates a flow chart of a method for analyzing a business requirement using artificial intelligence, in accordance with an embodiment.

FIG. 8 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

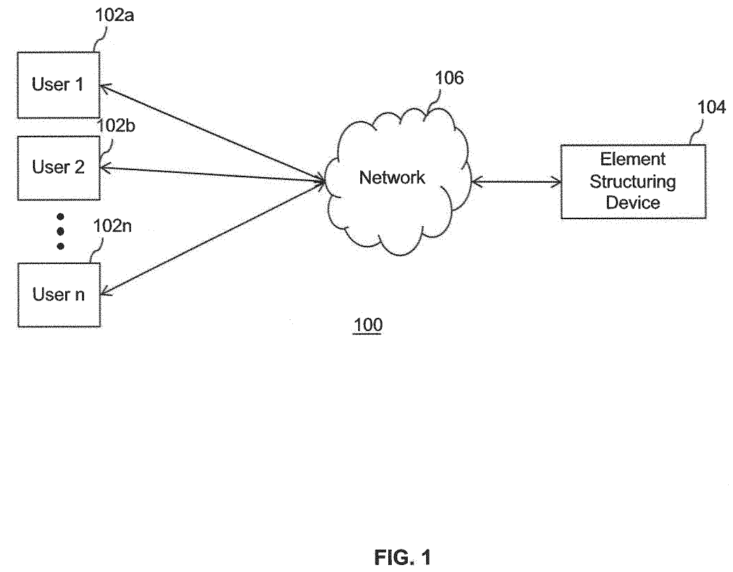

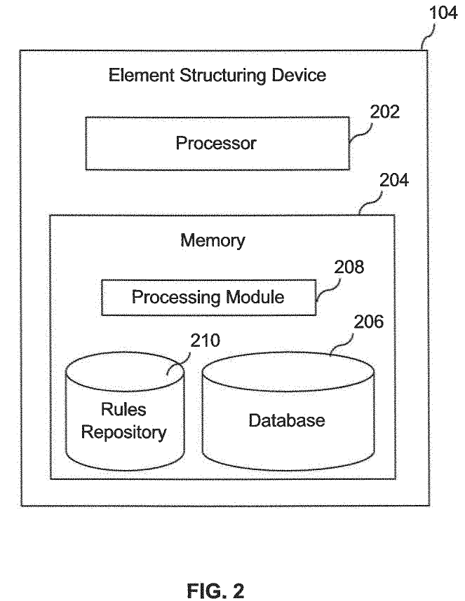

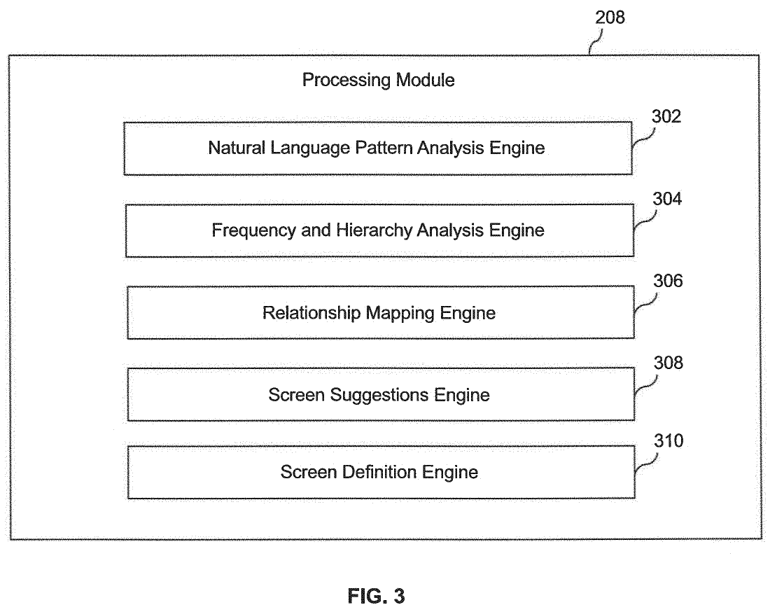

Referring to FIG. 1, an exemplary communication environment 100 in which various embodiments may function is illustrated. As shown, the communication environment 100 includes a plurality of user devices 102-a-n associated with a user may be connected to a server via a network 106, wherein the numbers n and m are arbitrary numbers representing same or different number of devices. Hereinafter, the user devices 102-a-n may collectively be referred to as “user devices 102”. The server herein represents an Element Structuring Device 104 for processing and structuring data according to rules of grammar. Details corresponding to functionalities of the Element Structuring Device are discussed further in conjunction with FIGS. 2 and 3.

In an embodiment, the network 106 may be a wired or a wireless network. The network 106 may be Local Area Network (LAN) that may be implemented using a TCP/IP network and may implement voice or multimedia over Internet Protocol (IP) using a Session Initiation Protocol (SIP). Further, the network 106 may further be connected to a gateway (not shown) which may be implemented as a gateway to a Private Branch Exchange (PBX) (not shown), a Public Switched Telephone Network (PSTN), or any of a variety of other networks, such as, wireless or cellular networks. In addition, the user devices 102 may be operably coupled to the network 106. Examples of the user devices 102 may include, but are not limited to a laptop, Smartphone, telephone, mobile phone, tablet, phablet, and Personal Digital Assistants (PDAs).

Further, the user devices 102 may refer to electronic devices that may be utilized by individuals to access and communicate with the Element Structuring Device 104. The user devices 102 may also be personal computers that implement various multimedia communication applications. Examples of such multimedia communication applications may include, but are not limited to Skype, Windows Messenger, iMesssage, WhatsApp, and WebEx. Additionally, the user devices 102 may use peripheral cameras, microphones and speakers to enable telephony and other multimedia services.

In an exemplary embodiment, the Element Structuring Device 104 may be configured for receiving unstructured data from a user and providing processed and structured information back to the user. The Element Structuring Device 104 may comprise at least one processor (not shown), a computer readable medium (not shown) storing instructions that, when executed by the at least one processor, causes the at least one processor to perform operations, wherein the operations comprising: receiving at least one business requirement, wherein the at least one business requirement comprises a plurality of elements; determining parts of speech associated with the at least one business requirement based on rules of grammar, wherein the parts of speech comprises at least one of nouns, verbs or adjectives; determining dependencies between the parts of speech by determining whether a state change of one object is accompanied by state change of another object; formatting the plurality of elements based on at least one of the dependencies, frequency of access, criticality of each of the plurality of elements or user type, wherein the frequency of access, the criticality of each of the plurality of elements and the user type is based on at least one of financial criticality, criticality for productivity or criticality for efficiency; and presenting the plurality of elements based on the formatting. Moreover, the frequency of access may be based on at least one of frequency of nouns and frequency of verbs.

In an embodiment, the presenting of the plurality of elements may be based on a timeline. The plurality of elements may also include at least one of mapping of subjects and objects to particular views and presenting logical flow of application. Further, the presenting the plurality of elements may further include defining each individual screen element.

In another embodiment, formatting the plurality of elements is performed by rearranging the plurality of elements according to a pre-set template. Moreover, the formatting of the plurality of elements is performed by prioritizing the plurality of elements based on type of business disclosed in the at least one business requirement. Further, the plurality of elements are presented by at least one of mapping of subjects and object to particular views and presenting logical flow of application. The plurality of elements may also be presented by defining each individual screen element.

Referring now to FIG. 2, a block diagram of an Element Structuring Device 104 as explained earlier in conjunction with FIG. 1, is illustrated. As illustrated in FIG. 2, the Element Structuring Device 104 includes a processor 202 and a memory 204 for data storage. The Element Structuring Device 104 also includes a network adapter (not shown) for connecting with the network 106 (as explained earlier in conjunction with FIG. 1).

The memory 204 may either be a primary memory or a secondary memory. Examples of the memory 204 may include, but are not restricted to Random Access Memory (RAM), cache memory, Hard Disk Drive (HDD), Solid State Drive (SSD), Compact Disk (CD), and portable memories. Moreover, the processor 202 represents at least one processor 202 and may comprise more than one processor 202.

The memory 204 stores therein a database 206, a processing module 208, and a rules repository 210. The database 206 may store historic data communicated to the Element Structuring Device 104. The database 206 may further store format templates for presenting information in an easy to understand and easy to perceive manner. The format templates may be updated, deleted, or added dynamically based on user instructions or based on artificial intelligence implemented for machine learning.

Further, the pre-defined rules stored in the rules repository 210 correspond to grammar rules of English language. However, the invention is not restricted to English language only. Any language having grammar rules can be used. Though, the invention is explained in context of English language, in particular, for ease of understanding only. The rules repository 210 can either be kept non-editable or can be updated dynamically for facilitating machine learning or for enabling authorized users to update the grammar rules as per requirements.

The processing module 208, as illustrated to be stored in the memory 204, uses the processor 202 to perform actions, e.g., receiving, storing, processing, updating, and transmitting data stored in the database 206 in accordance with pre-defined rules stored in the rules repository 210. In an embodiment, the processing module 208 is also capable of receiving, storing, processing, updating, and transmitting rules stored in the rules repository 210.

Notably, the rules repository 210 can be an integral part of the database 206 only. Further, the database 206 and the rules repository 210 can both be the integral part of the memory 204 only. However, the rules repository 210 and the databases 206 are illustrated separately only for the sake of ease of explanation to a person skilled in the art or having ordinary skills in the art.

In particular, functionalities or responsibilities of the processing module 208 may comprise receiving an input file from an end-user via network and prioritizing and organizing each element, in the received input file, according to grammar rules (as stored in the rules repository 210) associated with the received data and then to present the prioritized and organized data to the end-user using format templates (as stored in the database 206). This process further involves structuring of the received data/input file (associated with an application or software) based on grammar rules and more particularly, based on the type of noun, verb, or adjective of each element associated with the data. For example, elements associated with a specific type of nouns, verbs or adjectives are given priority based on a frequency of access of each element. Also, based on the highest frequency, each element associated with respective type of noun, verb or adjective are given priority on display screen.

The functionalities of the processing module 208 may further comprise formatting of screen elements based on a prioritized order and identifying information that needs to be presented to a user on the application or product at a particular point in time. The processing module 208 is further configured for presentation of the data of the application or product based on the formatted screen elements. For example, the screen elements may be prioritized by determining a number of views of each screen element among the plurality of screen elements. The formatting, by way of an example, may include placing prioritized screen elements at appropriate places in a website or an application based on identified information of a user (user type). Detailed functionalities of the processing module 208 are described further in conjunction with FIG. 3.

Referring now to FIG. 3, a block diagram of a module, such as the processing module 208, as explained earlier in conjunction with FIG. 2, is illustrated. The processing module 208 is broadly configured for processing and structuring received data (such as product related data) based on rules of grammar for better presentation of the data to a user in an easy to understand and easy to perceive manner.

For example, a humongous sized file, audio, video, graphics or a combination thereof may be received by the processing module 208 for processing and the processing module 208 may structurally summarize the received file for quick reference of a product designer. This will save humongous amount of time of the product designer in interpreting useful information from the humongous sized file. The representation of the structured file may be in form of text, graphics, audio, video, and a combination thereof.

Notably, the example provided above refers to only one of many embodiments of the invention. The example should not be considered as a scope restricting factor, as the example is selected only for the purpose of easy reference to a person having ordinary skills in the art in perceiving, implementing, and practicing the invention.

Further, as illustrated in the FIG. 3, the functionalities of the processing module 208 are further categorized under five different module engines, such as, natural language pattern analysis engine 302, frequency and hierarchy analysis engine 304, relationship mapping engine 306, screen suggestions engine 308, and screen definition engine 310.

The natural language pattern analysis engine 302 is configured to sift through received at least one business requirement (refers to a received input file) and to identify parts of speech within, based on rules of grammar. The natural language pattern analysis engine 302, in particular, culls business requirements into component parts of multiple nouns, adjectives and verbs. The output of the analysis is then passed on to the frequency and hierarchy analysis engine 304. The frequency and hierarchy analysis engine 304, organizes received data (from the natural language pattern analysis engine 302) by frequency of occurrence and relative hierarchy.

Primary objective of the frequency and hierarchy analysis engine 302 is to identify priority and dependency. It is considered here that frequency of occurrence of any component must indicate its priority. Further, relationship mapping engine 306 processes received data (from the natural language pattern analysis engine 302) to project relationship of the multiple nouns (i.e. the subjects and objects) with each other through verbs and through change in adjectives. The degree of separation between them is used to determine their relative positions. Also, the relationship mapping engine 306 is configured to identify which of the multiple subjects and objects make up component views.

Further, the screen suggestions engine 308 projects possible mapping (received from the relationship mapping engine 306) of the multiple subjects and objects in relation to real estate (i.e., presentable layout of the product data on the screen). Notably, views are organized based on sequential occurrence of each subject. In an embodiment, the screen suggestions engine 308 may be used to interpret what subjects and objects are placed in which views and define the logical flow of the application, representing number of views, as required.

Similarly, the screen definition engine 310 is configured to define individual screen elements for presentation to a user, based on whether a subject is changing state of an adjective, or merely displaying the state. Accordingly, the screen definition engine 310 is configured to reach the ultimate definition of the screen in the most quantifiable format possible, where the relative frequency of the verb and the hierarchy will determine the distribution of real estate.

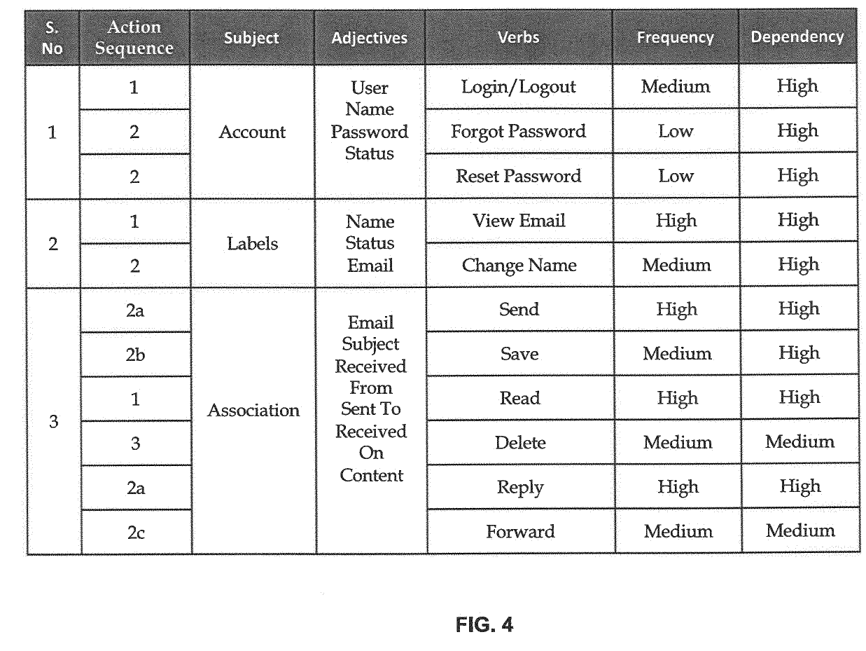

Referring now to FIG. 4, a data table is illustrated with various data elements stored in a structured and processed form, in an exemplary embodiment. The data table represents a processed form of data processed from an input file based on grammar rules. The data stored in the data table is yet not represented in a user presentable form though. The data is only represented in a structured form, from which data can be extracted and presented according to various pre-stored data presentation templates for representing data in a more convenient and appealing manner to an end user. The focus of the representation must be to ease the end user from the burden of deducing usefulness of the presented data.

Further, the data illustrated in the FIG. 4 represents data processed from an input file uploaded by an end-user corresponding to an e-mail client product. The data represented in the data table is provided only for the purpose of ease of understanding of a person having ordinary skills in the art. The data does not represent complete layout of structured data, but only provides a glimpse of an instance of the structured data that can be a possible outcome from a system, as disclosed.

In the row 1 of the data table ‘account’ is defined as an object, which an end user or an email subscriber can access in order to access their emails. In the row 2 of the data table, ‘label’ is defined as an object, which exists by virtue of the actions taken by the end user in collecting emails to be viewed in a specific state. Similarly, in the row 3 of the data table, ‘email’ is defined as an object by virtue of the end user performing multiple frequent actions that deem the application necessary.

Referring back to the row 1, the row 1 further represents that frequency of usage of the verbs such as Login/Logout in context of the subject ‘account’ and in reference to the adjectives used such as ‘user name’, ‘password’, etc. was recorded as of ‘Medium’ category. The frequency may also be represented in terms of, but not limited to exact amount, percentage, mean, standard deviation, and average.

Similarly, the row 1 further illustrates that dependency of the verbs such as the Login/Logout was recorded as ‘high’ in relation to their corresponding subjects and adjectives. The invention may use any method of categorizing an amount as ‘high’, ‘medium’, or ‘low’, such as, based on a pre-set threshold or a similar method. Further, the data table as illustrated in row 1 may provide explicit information to a product designer or developer, in terms of structural elements as defined in a product statement disclosure file, for reference. This may help the product designers in speeding up the understanding and summarizing work of disclosure statements, without chances of human errors, and based on traceable facts and figures.

Further, as shown in the FIG. 4, in the column ‘action sequence’, the action sequence for Logging in must be first, followed by second preference to if the user forgot password, or if user wants to reset password. Similarly, after logging in, first preference should be given to viewing/reading of email in comparison to tasks of second preferences, such as, send, save, reply, forward, etc. Also, action designing for tasks such as delete email may have the third level preference. This way, new product disclosure statements may also be parsed intelligently by computer systems to determine tricky information such as action sequences, as described above.

By way of example from an emerging industry such as experience designing industry, there is a perception that planning for experience design is tedious and unpredictable work, sometimes maybe not worth the value it brings to the table. The invention thereby outlines a solution to such problems through a mechanism of identifying ‘scale and size’ based on the entities and activities. For example, mapping out the nouns, verbs, their frequency, and relative dependency helps identify the scale of the project and further allows for integration of design as part of every project cycle.

Traditional mechanisms of gathering and framing the scale of a project used guessing methods. For example, guessing based on previous experiences, number of views anticipated for a designed and developed web page, complexity of each webpage, approximation of a ratio of simple:medium:complex levels in a webpage, and then accounting for a buffer. Alternate strategy estimations include accounting for a certain number of user groups and extrapolating the level of interaction of each user. Further, depending on skill of a person estimating, this traditional process could result in vastly varying scales and estimates, which would result in challenging integration and an estimate that may or may not tolerate the scrutiny of a rigid product lifecycle. Current scale and size are determined by an approximation of size and number of pages. This is highly dependent on assumptions and a level of skill that is very relative.

Consider a simple device such as a pen. The user objective would be that the pen was reliable and easy to hold and operate with. The business objective maybe to ensure that all its users can use the pen on as many surfaces as possible. Perhaps to be unaffected by external elements such as water or oil and be sold at a particular price point with a particular margin. The activities in this case do not simply include “write”. The activities that a user performs include carrying the pen on their body or in a bag along with other objects, using it to point at a screen maybe using it to open an envelope. The type of user would determine the amount of time that the pen would be used and the design would subsequently be impacted. If this were being sold at a high price point, executives would likely use it and writing would be a secondary activity, the pen would convey value and be always visible. If this were being sold at a low price point, perhaps students would use it and they would use it primarily to write with and longevity would be a more desirable attribute as compared to appearance.

The noun in this case would be the user type, the activities performed would be the verbs and the frequency of the activities and the level of dependency between the various activities would determine the design scale. For instance, if it did not write well, it would be a failure for both users. But if it were to not carry well in a suit jacket and have a suitable affordance, it would be a failure to the executive. For the student if it didn't last for at least a few months and have an ergonomic grip, it would be a failure.

At any rate, time taken to design the pen is determined by these activities and the decisions made at each point would be traceable to each user group. A reputed pen making company may decide to make two different products to cater to these two user groups and the design cycle for each would be different. The process the company may follow to scale each of the two designs may comprise the process of Identifying unique user groups for each desired product. A user group is generally characterized by activities or tasks. A lack of overlap in environment or desired outcome separates one user group from another. For example, in a leave application system, an employee may apply for leave and interact with elements such as date and time by virtue of selecting a day off. A manager on the other hand would interact with the same elements but to check if the day selected is clear of major events and to approve the time requested.

The next step may be to identify the basic elements. For example, identifying various elements that each user groups interacts with as part of their activities with a product. For a pen this may be the cap, the body, the nib, the ink, the grip. For a leave application, this may be the day and the reason for the leave application. For a mail management system, this maybe an email, a folder, an account. Capture these various objects that undergo a change in state by virtue of an activity that the user from the user groups performs.

Thereafter, each activity catalogued by the user group may be examined. These are the explicit and implicit activities required for a product to be a success. For example, composing an email maybe explicit, but auto-saving a draft on an abandoned email might be an implicit one for a mail management application. Capturing these individual activities and associating them with what changes they bring about is critical to the process.

The next step would be to evaluate frequency and dependency. For example, to evaluate relative frequency of each activity, the higher the frequency of an action, the more prominent the visibility could be of various elements and the trigger for a call to action. For instance, “saving an email” maybe a very frequent activity or the button to open/close or turn on/off a pen could be very frequent. Visibility of access or this button would have to be very high.

Similarly, dependency is the clincher in this process. The dependency of each activity with relation to the other determines visibility and design decisions. If an account can't be logged in, then an email can't be composed. If an email can't be composed, it can't be saved as a draft or sent. The objective of the product is defeated in its entirety.

Putting it altogether, in reference to the FIG. 4, the number of user groups, the number of activities, the impacted elements and the state change will provide an indication of the number of views, number of aspects required. For example, with a single user group for an email management system, the number of elements and their relative activities and state changes are captured. The scale of the project for this limited scope of elements and activities could be number of views for the Email to be 1*2 (i.e., number of changes in status), number of views for the Account to be 1*3, number of views for the Label to be 1*1, number of views for the Association to be 1*1.

Further, the combination of frequency and dependency would determine priority of placement of Call to action. For example, action to select an email to read would be highest at 1, action to reply and action to send would be next at 2a and so on. These would be relatively weighted to be able to catalogue design decisions.

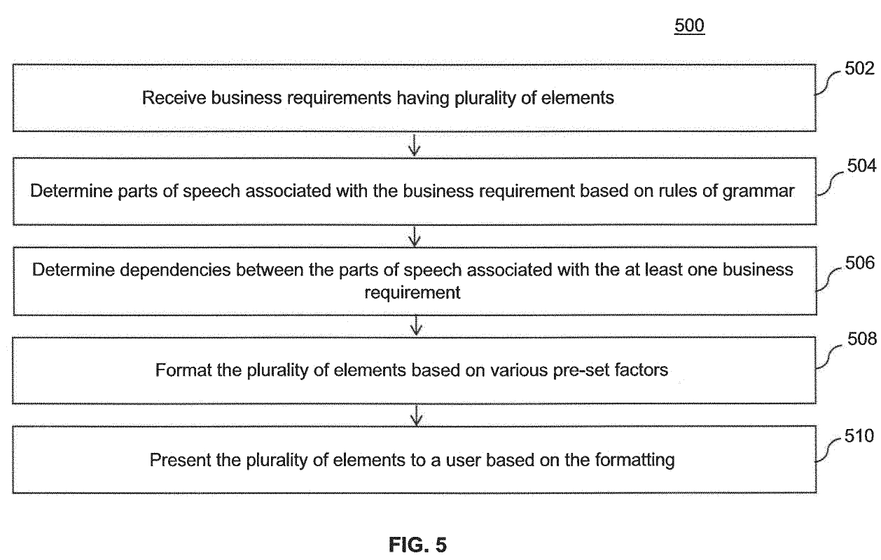

Referring now to FIG. 5, a flowchart of a method 500 of managing a user experience design is illustrated, in accordance with an embodiment. At step 502, a server or a device implementing the Element Structuring Device 104 (as described in conjunction with FIG. 1 and FIG. 2) receives at least one business requirement comprising a plurality of elements. The business requirement may be received in the form of an input file or media from an end user, over a network. The Element Structuring Device 104 may receive the data from a plurality of end users at different time stamps, via different media channels, in different media format (i.e., audio, video, text, graphical format.) The processor 202 may thus first collate all such data received from multiple users under a common reference identifier before processing of data in further steps.

The input file or media may comprise text, graphics, audio, video, or a combination thereof. In an embodiment, an end user may upload such input file or media on a webpage, which is received by the Element Structuring Device 104. Further, the received input file may comprise at least one business requirement in an embodiment. The at least one business requirement may pertain to any information necessary for development of a business, a product, or a service.

At step 504, the Element Structuring Device 104 may determine parts of speech associated with the received business requirement based on rules of grammar for segregating useful information into parts of speech. The rules of grammar may be pre-stored in a database accessible to the Element Structuring Device 104. The rules of grammar may be static or may be dynamically updateable by the Element Structuring Device 104, for facilitating machine learning process in lieu of artificial intelligence. Further, the parts of speech may include nouns (i.e. subjects and objects), verbs, and adjectives. The parts of speech may include at least one of nouns, verbs or adjectives. The nouns include at least one of subjects and objects, the verbs may include actions taken by the subject on the object, and the adjectives may include state of the object.

The Element Structuring Device 104 may then use the segregated information for identifying plurality of elements associated with the at least one business requirement. The Element Structuring Device 104 may further use the identified plurality of elements in labeling activities performed by subjects as verbs. The Element Structuring Device 104 may also use the identified elements for labeling elements on which activities are performed by subjects as objects. The Element Structuring Device 104 may further use the identified elements for identifying attributes of the objects, as affected.

Thereafter, at step 506, the Element Structuring Device 104 determines dependencies between the parts of speech associated with the identified elements of the business requirements. The Element Structuring Device 104 may parse the elements for determining criticality of the identified elements and frequency of use of the identified elements.

At step 508, the Element Structuring Device 104 formats the plurality of elements based on various pre-set factors, which may include, but are not limited to the dependencies between the parts of speech, frequency of access, criticality of each of the plurality of elements or user type. The frequency of access, the criticality of each of the plurality of the elements, and the type of the end user may be based on the at least one business requirement.

Further, in an embodiment, the Element Structuring Device 104 may format the identified and determined elements into suitable template(s) (via rearrangement of data according to templates) and thereafter present this information, at step 510, in a human readable format to end users. This information may be presented to devices used by the end users over network, or by uploading the data to a webpage, from where the end users may access the uploaded information. In an embodiment, the Element Structuring Device 104 may possess multiple data format templates for information presentation according to data attributes or according to end user requirements.

In an embodiment, the formatting process of data may include prioritizing the determined data as per type of business disclosed in the received business requirement, as per pre-stored revenue information corresponding to the type of business, as per pre-stored customer information of the type of business, or as per pre-stored success history of similar business requirements.

Further, in an embodiment, the Element Structuring Device 104 may receive feedbacks on presented data from the end-users for further enhancing the user experience. The Element Structuring Device 104 may store such feedbacks in database for ensuring improvements over all future requests, transactions, or projects in lieu of artificial intelligence and machine learning process. The feedback may be related to improvement in presentation of information via a modified template, or via modified representation of presented data, which can be reverse engineered for automatically creating or modifying existing templates. The Element Structuring Device 104 may also provide tailored services to end-users based on their feedbacks by updating presentation format in real time or in future projects.

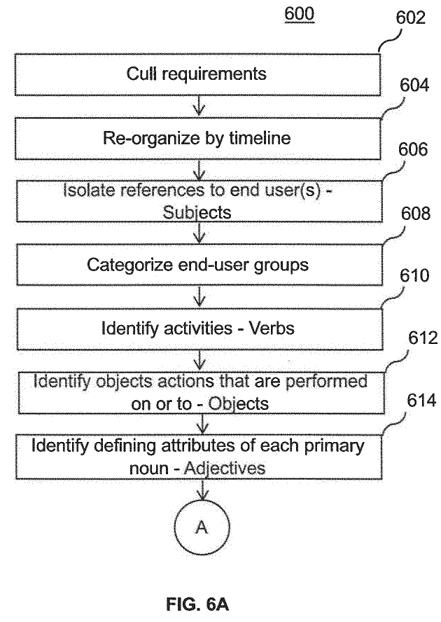

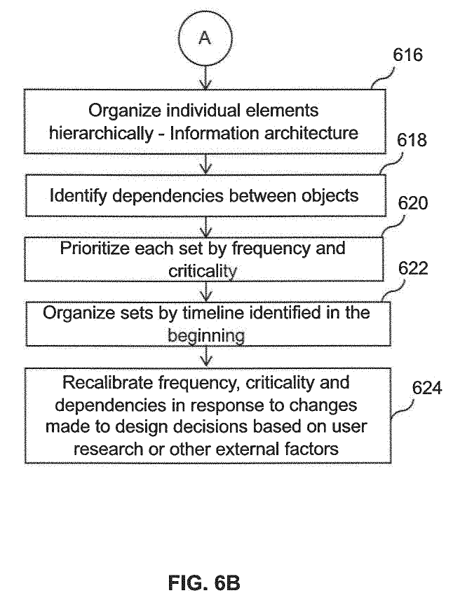

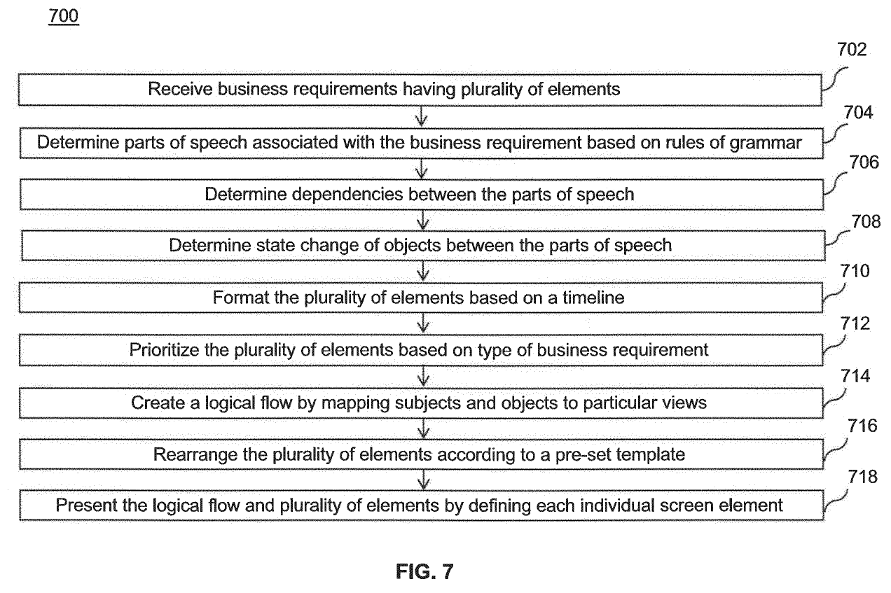

More details corresponding to each step illustrated in FIG. 5 are provided further in conjunction with FIGS. 6A, 6B, and 7.

Referring now to FIGS. 6A and 6B, a flowchart of a method 600 of structuring data related to experience designing based on rules of grammar is illustrated, in accordance with an embodiment. At step 602, an Element Structuring Device 104 (as described in conjunction with FIG. 1 and FIG. 2) collates all functional requirements or ‘Business expectations’ from an end user device. Further, at this step, details that are not pertinent to experience design may be eliminated.

At step 604, the Element Structuring Device 104 re-organizes content in a timeline of expected sequence of events to organize information from the perspective of the end-user as time is considered as the most accurate rendition. Thereafter, at step 606, the Element Structuring Device 104 isolates references to end user(s) subjects. In other words, Element Structuring Device 104 identifies and notates references to end-users for evaluation. For example, presence of different user types, administrators, shopper, or customer service. Identification of frequency of references is another important aspect.

At step 608, the Element Structuring Device 104 categorizes end-user groups by identifying different user types based on types of activities performed, both on and outside the application/product, to achieve a complete product. The Element Structuring Device 104 further identifies minor overlap, difference in overlap, or no overlap in activity type. Thereafter, at step 610 the Element Structuring Device 104 identifies activities in form of verbs. For example, in course of identifying subjects, activities performed by subjects would be identified. These activities or actions are generally verbs.

At step 612, the Element Structuring Device 104 identifies object actions that are performed on or to objects. For example, in course of identifying subjects and activities performed by subjects, the objects on which these are performed are identified. For the purpose of experience design the presentation of these objects or primary nouns are critical. Thereafter, at step 614, the Element Structuring Device 104 identifies defining attributes for each primary noun, i.e., adjectives. For example, adding an item to cart would affect an attribute of the noun “cart”, quantity and the attribute of the noun “item”. Identifying the attributes of each object affected and the tense of each activity will enable determining the display of a changed state.

At step 616, the Element Structuring Device 104 organizes individual elements hierarchically in form of information architecture. For example, organizing content by user (subject) yields subject, verbs, objects, and adjectives causing state change. Thereafter, at step 618, the Element Structuring Device 104 identifies dependencies between objects, i.e., if the state change of one object is simultaneously accompanied by the state change of another object.

At step 620, the Element Structuring Device 104 prioritizes each set by frequency and criticality, i.e., prioritizing each state change based on frequency of verb and business criticality. The frequency relates to how often the activity is performed to individual instances of the object. For example, frequency of reading contents of email. Similarly, criticality refers to how critical is the activity to the success of the product. For example, “Adding an item” to cart being more critical than “saving for later” activity.

At step 622, the Element Structuring Device 104 organizes sets by timeline identified in the beginning, i.e., to organize with weighted priority and associated dependency in line with timeline identified at the beginning of the process. The Element Structuring Device 104 organizes the sets in such a way that each view is designed with known objects and states to be displayed with screen space allocated by criticality and frequency for optimal results. Thereafter, at step 624, the Element Structuring Device 104 recalibrates frequency, criticality, and dependencies on changes to design decisions based on user research or other external factors, for retaining traceability.

Referring now to FIG. 7, a flowchart of a method 700 for analyzing a business requirement using artificial intelligence is illustrated, in accordance with an embodiment. At step 702, the Element Structuring Device 104 (as described in conjunction with FIG. 1 and FIG. 2) receives a file from a user over a network. The file may comprise at least one business requirement. The business requirement may comprise text, graphics, audio, video, or a combination thereof. In an embodiment, the business requirement may also pertain to any information necessary for development of a business, a product, or a service.

Further, at step 704, the Element Structuring Device 104 may determine various parts of speech associated with the received business requirements based on rules of grammar. The analysis of the various parts of speech may be necessary for segregating useful information out of the received file. The analysis of the parts of speech may be targeted to identify nouns, verbs, and adjectives, wherein the nouns comprise at least one of subjects and objects. Accordingly, the verbs may comprise actions taken by the subject on the object and the adjectives may comprise state of the object.

In an embodiment, the rules of grammar may be pre-stored in a database which may be accessible to the Element Structuring Device 104. The rules of grammar may be static or may be dynamically updateable by the Element Structuring Device 104, for facilitating machine learning process in lieu of artificial intelligence.

At step 706, the Element Structuring Device 104 may parse the plurality of elements in the business requirements to determine dependencies between the parts of speech and of elements on each other. The dependencies between the elements may further represent dependencies between the various subjects and objects pertaining to the business requirements, which may be useful information for the user. Thereafter, at step 708, the Element Structuring Device 104 may further determine whether a state change of one object is accompanied by state change of another object of the business requirements, for determining more useful and relevant information for the user. It will be appreciated by a person skilled in the art that determination of change in the state of the objects pertaining to business elements represents a very relevant information for a user in interpreting the business requirements briefly.

At step 710, the Element Structuring Device 104 formats the plurality of elements of the business requirements based on a timeline for providing time specific information to the user pertaining to the received business requirement. Thereafter, at step 712, the Element Structuring Device 104 prioritizes the plurality of elements as per their importance in the business requirement. The prioritized data may then be used by the Element Structuring Device 104, at step 714, to create a logical flow of business elements by mapping subjects and objects to particular views.

Thereafter, at step 716, the Element Structuring Device 104 re-arranges the plurality of elements associated with the business requirements according to pre-set templates, which may or may not be user defined. It will be appreciated by a person skilled in the art that default templates for illustrating meaningful information may also be used. However, tailored templates according to user's requirements are preferable. The users may be able to dynamically update a template for receiving processed information as per his/her requirements. After rearrangement of the plurality of elements as per the pre-set template, the Element Structuring Device 104, at step 718, maps the re-arranged data into the pre-set template and presents the template information to the user by defining each individual screen elements corresponding to the processed business requirement.

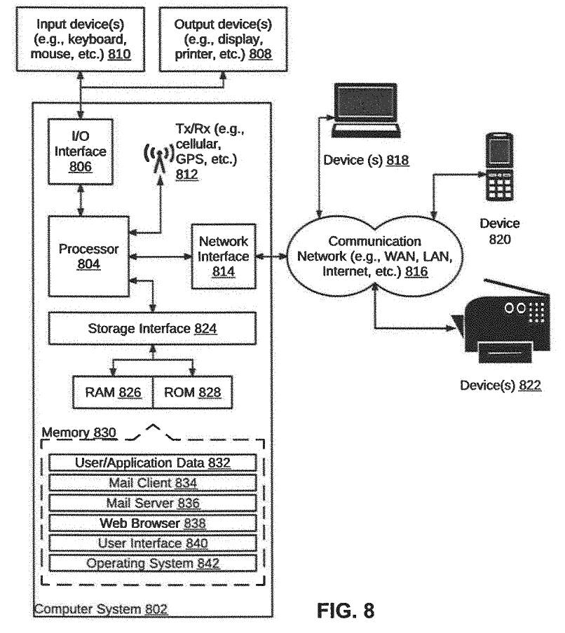

FIG. 8 illustrates a block diagram of an exemplary computer system 802 for implementing various embodiments is disclosed. Computer system 802 may comprise a central processing unit (“CPU” or “processor”) 804. Processor 804 may comprise at least one data processor for executing program components for executing user- or system-generated requests. A user may include a person, a person using a device such as such as those included in this disclosure, or such a device itself. Processor 804 may include specialized processing units such as integrated system (bus) controllers, memory management control units, floating point units, graphics processing units, digital signal processing units, etc. Processor 804 may include a microprocessor, such as AMD Athlon, Duron or Opteron, ARM's application, embedded or secure processors, IBM PowerPC, Intel's Core, Itanium, Xeon, Celeron or other line of processors, etc. Processor 804 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 804 may be disposed in communication with one or more input/output (I/O) devices via an I/O interface 806. I/O interface 806 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 806, computer system 802 may communicate with one or more I/O devices. For example, an input device 808 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 810 may be a printer, fax machine, video display (e.g., cathode ray tube (CRT), liquid crystal display (LCD), light-emitting diode (LED), plasma, or the like), audio speaker, etc. In some embodiments, a transceiver 812 may be disposed in connection with processor 804. Transceiver 812 may facilitate various types of wireless transmission or reception. For example, transceiver 812 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 804 may be disposed in communication with a communication network 814 via a network interface 816. Network interface 816 may communicate with communication network 814. Network interface 816 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 814 may include, without limitation, a direct interconnection, local area network (LAN), wide area network (WAN), wireless network (e.g., using Wireless Application Protocol), the Internet, etc. Using network interface 816 and communication network 814, computer system 802 may communicate with devices 818, 820, and 822. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 602 may itself embody one or more of these devices.

In some embodiments, processor 804 may be disposed in communication with one or more memory devices (e.g., a RAM 826, a ROM 828, etc.) via a storage interface 824. Storage interface 824 may connect to memory devices 830 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 830 may store a collection of program or database components, including, without limitation, an operating system 832, a user interface application 834, a web browser 836, a mail server 838, a mail client 840, a user/application data 842 (e.g., any data variables or data records discussed in this disclosure), etc. Operating system 832 may facilitate resource management and operation of computer system 802. Examples of operating system 832 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 834 may facilitate display, execution, interaction, manipulation, or operation of program components through textual or graphical facilities. For example, user interfaces may provide computer interaction interface elements on a display system operatively connected to computer system 802, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 802 may implement web browser 836 stored program component. Web browser 836 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 802 may implement mail server 838 stored program component. Mail server 838 may be an Internet mail server such as Microsoft Exchange, or the like. Mail server 838 may utilize facilities such as ASP, ActiveX, ANSI C++/C#, Microsoft .NET, CGI scripts, Java, JavaScript, PERL, PHP, Python, WebObjects, etc. Mail server 838 may utilize communication protocols such as internet message access protocol (IMAP), messaging application programming interface (MAPI), Microsoft Exchange, post office protocol (POP), simple mail transfer protocol (SMTP), or the like. In some embodiments, computer system 802 may implement mail client 840 stored program component. Mail client 840 may be a mail viewing application, such as Apple Mail, Microsoft Entourage, Microsoft Outlook, Mozilla Thunderbird, etc.

In some embodiments, computer system 802 may store user/application data 842, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Embodiments of the invention may provide a number of advantages depending on its particular configuration. First, the invention, allows for a structured predictable mechanism to define user experience of a product or application or any presentation of data. Next, the invention classifies large content in a hierarchical format based on type of nouns, verbs, and/or adjectives will facilitate a user to easily decide what is important and what is not. Moreover, the invention provides a method to measure or anticipate expected time taken to complete presentation aspects of user experience design. Furthermore, the invention provides traceability to design decisions as determined through available user requirements or user research.

Additional benefits provided by the invention includes provision of a mathematical expression of a system with quantifiable metrics for each element (instead of assumptions based model), predictable process that can be applied by professional of any skill set to arrive at the same estimate, undeniable traceability between design decisions to a business objective to a user objective, and clear mapping of user groups to views, such as, mapping of time and effort to work required based on number of concepts to be fashioned, and so on.

Further, embodiments of the invention disclose a methodology of structuring data based on the rules of grammar. Average business requirements of a product are written in natural language and at best a case includes actors and actions with functional and non-functional requirements. The methodology intends on disassembling these requirements into component parts of nouns, verbs and adjectives. For instance, nouns would be subjects or objects as identified in each descriptive functional requirement. If determined to be an end-user or subject they would be classified as a type of noun taking actions and hence be the representative user group. If determined to be a noun acted upon or the object, they would be classified as the nouns to receive actions and hence be represented as part of the presentation layer.

Further, the actions taken by the subject on the object, or the activities that are to be facilitated by the product, are examples of the verbs. The frequency of nouns or objects determines their relative priority to identify primary nouns. The frequency of these actions as it pertains to the user group and the criticality in terms of financial, productivity or efficiency of these users determines the primary verbs.

Each action taken on the object represents a change in state of the object, this state is defined by adjectives in natural language and display of this status is what allows the end-user to take or not take actions. The existence of the state of the object is a defining adjective or attribute and capture or display of these attributes is also a necessary aspect of user experience. The tense of language determines the view or change in view of each of these component parts and the applicability of each aspect at each point in time.

For example, in an “email application”, all elements containing the word ‘email’ may be considered as nouns. However, in reality, the word ‘email’ may be associated with all types of non-editable universal labels such as ‘draft email’, ‘starred email’, ‘inbox email’, ‘tab email’ and the like. The aspect that is common among these is the label or rather the presence of a “group” of emails, which is described by its state or adjective. Among these groups, “inbox” may have the highest frequency of access, so that the group ‘inbox’ is a primary noun. Similarly, such groups may also be associated with verbs describing primary actions of respective nouns. By a way of an example, the noun ‘inbox’ may be associated with actions (verbs) such as ‘compose’, ‘refresh’, ‘settings’, ‘sent’, ‘reply’, ‘mark’ and the like. Accordingly, each verb may be arranged based on their highest frequency of access and prioritized, such that the verb ‘compose’ may have a highest priority when compared with the verbs ‘refresh’, ‘settings’, ‘sent’, ‘mark’ etc. Further, each adjective may be an attribute of a noun and may be arranged based on the highest frequency of access and prioritized. For example, for a noun ‘email’, adjectives or attributes may include ‘subject’, ‘from’, ‘to’, a state representing whether the email is ‘read/unread’, ‘content’ and the like.

Such a fool-proof methodology allows for a clear determination of the number of views and screen elements to be placed and is the science portion of the discipline, allowing for the art to take over subsequently. Moreover, such structuring of data significantly streamlines the amount of time involved in experience mapping and allows a professional to predict with closer accuracy, the time taken and the success of a design. It also allows for traceability as to why design decisions were made with lack of chum at a later point in the product lifecycle.

The specification has described systems and methods for processing business requirement statements and converting them into a structural, meaningful, and human readable format. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of managing user experience design, the method comprising:
receiving, by an Element Structuring Device, at least one business requirement, wherein the at least one business requirement comprises a plurality of elements;
determining, by the Element Structuring Device, parts of speech associated with the at least one business requirement based on rules of grammar;
determining, by the Element Structuring Device, dependencies between the parts of speech associated with the at least one business requirement;
formatting, by the Element Structuring Device, the plurality of elements based on at least one of the dependencies, frequency of access, criticality of each of the plurality of elements or user type, wherein the frequency of access, the criticality of each of the plurality of the elements and the type of the end user is based on the at least one business requirement; and
presenting, by the Element Structuring Device, the plurality of elements based on the formatting.

2. The method of claim 1, wherein the at least one business requirement comprises at least one of a text file, audio file or video file.

3. The method of claim 1, wherein the parts of speech comprise at least one of nouns, verbs or adjectives, wherein the nouns comprise at least one of subjects and objects, wherein the verbs comprise actions taken by the subject on the object, wherein the adjectives comprise state of the object.

4. The method of claim 1, wherein determining the dependencies between the parts of speech comprises determining whether a state change of one object is accompanied by state change of another object.

5. The method of claim 1, wherein the criticality of each of the plurality of elements is based on at least one of financial criticality, criticality for productivity or criticality for efficiency.

6. The method of claim 1, wherein the frequency of access is based on at least one of frequency of nouns and frequency of verbs.

7. The method of claim 1, wherein the method further comprises organizing the plurality of elements based on a timeline.

8. The method of claim 1, wherein formatting the plurality of elements comprises rearrangement of the plurality of elements according to a pre-set template.

9. The method of claim 8, wherein formatting the plurality of elements further comprises prioritizing the plurality of elements based on type of business disclosed in the at least one business requirement.

10. The method of claim 1, wherein presenting the plurality of elements comprises at least one of mapping of subjects and objects to particular views and presenting logical flow of application.

11. The method of claim 10, wherein presenting the plurality of elements further comprises defining each individual screen element.

12. A system for managing user experience design, the system comprising:
at least one processor;
a computer readable medium storing instructions that, when executed by the at least one processor, cause the processor to perform operations, the operations comprising:
receiving at least one business requirement wherein the at least one business requirement comprises a plurality of elements;
determining parts of speech associated with the at least one business requirement based on rules of grammar;
determining dependencies between the parts of speech associated with the at least one business requirement;
formatting the plurality of elements based on at least one of the dependencies, frequency of access, criticality of the plurality of elements or user type wherein the frequency of access and the criticality of each of the plurality of the elements and the type of the end user is based on the at least one business requirement; and
presenting the plurality of elements based on the formatting.

13. The system of claim 12, wherein the parts of speech comprises at least one of nouns, verbs or adjectives, wherein the nouns comprise at least one of subjects and objects, wherein the verbs comprise actions taken by the subject on the object, wherein the adjectives comprise state of the object.

14. The system of claim 12, wherein the processor is configured to determine the dependencies between the parts of speech by determining whether a state change of one object is accompanied by state change of another object.

15. The system of claim 12, wherein the processor is further configured to organize the plurality of elements based on a timeline.

16. The system of claim 12, wherein the processor is configured to format the plurality of elements by rearranging the plurality of elements according to a pre-set template.

17. The system of claim 12, wherein the processor is further configured to format the plurality of elements by prioritizing the plurality of elements based on type of business disclosed in the at least one business requirement.

18. The system of claim 12, wherein the processor is configured to present the plurality of elements by at least one of mapping of subjects and objects to particular views and presenting logical flow of application.

19. The system of claim 12, wherein the processor is further configured to present the plurality of elements by defining each individual screen element.

20. A non-transitory computer-readable storage medium for managing user experience design comprising instructions, which when executed by a computing device, causes the computing device to:
receive at least one business requirement, wherein the at least one business requirement comprises a plurality of elements;
determine parts of speech associated with the at least one business requirement based on rules of grammar;
determine dependencies between the parts of speech associated with the at least one business requirement;
format the plurality of elements based on at least one of the dependencies, frequency of access, criticality of each of the plurality of elements or type of the end user wherein the frequency of access, the criticality of each of the plurality of elements and type of the end user is based on the at least one business requirement; and
present the plurality of elements based on the formatting.
